(19) United States
(12) Patent Application Publication
(10) Pub. No.: US 2016/0281676 A1
(43) Pub. Date: Sep. 29, 2016

(54) Mechanism for hydropower generating system using buoyancy energy/force

(71) Applicant: Ali Shokohi, Tehran (IR)

(72) Inventor: Ali Shokohi, Tehran (IR)

(21) Appl. No.: 14/455,898

(22) Filed: Aug. 9, 2014

(51) Int. Cl. F03B 17/06

(52) U.S. Cl. CPC F03B 17/06

(57) ABSTRACT

A mechanical power generating system including housing with three vertical pipes and a piston which is moving upward due to water pressure under the piston and downward due to its weight creates a cycle of reciprocating machine. Fluid is being led to downstream of the system from one of the pipes by opening the discharge valve of the aforementioned pipe; water pressure exerts force on the piston which is located in the other parallel pipe and consequently the piston moves, this would basically be the power generation cycle. In the next step discharge valve of the second pipe is opened and leads the water to the drainage. This step simply facilitates the piston's return to the initial position.

The present invention relates to a novel mechanism of generating power. Particularly the present invention relates the method of generating mechanical force from the water head difference existed in rivers without using any turbine or Hydro-rotary machine.

### BACKGROUND OF THE INVENTION

There is an ever increasing demand for energy in the world. The main resource of energy has been the fossil fuels and coals, which have been used to generate electricity which is the most convenient and desired type of energy. However, due to the problems with burning fossil fuels such as pollution, greenhouse effect, and the limited resources, there is a crucial need for other energy resources. Many researchers throughout the world have dedicated their time and research facilities to find new ways of harnessing energy from renewable sources but the progress and achievements has not been satisfactory yet.

Human beings have been always relying on hydrocarbon-based fuels. Arboreal fuels such as woods and coal have been utilized as long as mankind knows about fire. About two centuries ago, we started extracting energy from fossil fuels. However, there are some serious concerns with them. Namely, the changes occurred to environmental condition of the earth due to oil and gas production, transportation and consumption.

Air pollution in cities and industrial parks as well as the greenhouse effect are the most tangible detriments that come with burning the fossil fuels. Moreover, Population growth and emergence of new industries have rendered an increasing energy demand in the world in the past decades. Thus, it is needless to say that we cannot depend only on fossil fuels. Many researchers throughout world started to work on new ways to provide the required energy for continuing life on earth. Nuclear Energy, Solar energy, wind energy, and many other energy sources has been employed in order to generate electricity which is the most convenient form of energy to be used by both household and industrial energy consumers. However, there have been some serious flaws as the demand for oil and gas is still increasing.

Renewable sources of energy are the most promising candidates to be considered as the energy resources for future life on earth. As aforementioned above, there have been some efforts to find efficient ways for extracting energy in solar radiations and wind currents. However, the electricity generated from these resources is not economic. Because, the approaches applied in solar cells and wind turbines are not satisfactorily efficient and also the equipments used in these types of power plants are highly intricate and expensive. Using biomass is another source of energy which is utilized to generate power, but the source of this energy is not as widespread as wind or solar energy.

One another energy resource that could be a significant energy resource is the mechanical energy potential in natural water currents. Human beings have been extracting electricity by storing water behind dams and running water turbines. There are several difficulties and also environmental issues with building dams and storing water in artificial lakes. The present invention addresses most of issues in using running waters.

### SUMMARY OF INVENTION

This invention discloses an innovative system that can be used with very low expenses, in comparison with existing electricity generation methods, in order to extract the energy in water currents. Ability to extract energy of the rivers with great mass flow rates is the other main issue is addressed in the present invention. In this system the need for expensive and highly technological machineries is eliminated. This system utilizes a light voluminous piston, free to move back and forth inside a cylindrical well. The piston falls in a well with the water from a river current and then ascends as the buoyancy force is exerted on it. Indeed we spend water's energy to suspend the piston in the bottom of the system and obtain its energy when moving upward in the well. When the piston ascend to their top most point, water inside the well discharges to the downstream of the river and the piston descend to its initial point after that the cycle is repeated.

### BRIEF DESCRIPTION OF DRAWINGS

FIG. 1, Represents a conceptual manner of the water extraction from the river into the open channel.

FIG. 2, displays where and whether the power generation system is installed near the river.

FIG. 3 is a schematic of the power generating system when the first check valve has been opened and the hollow piston is moving upwards (first stroke of the machine). In this stroke the second valve has been closed.

FIG. 4 is a schematic of the power generating system when the second check valve has been opened and the hollow piston is moving downward (second stroke of the machine). In this stroke the first valve has been closed.

FIG. 5 is a schematic of the water leakage absorption mechanism using orifice and pump system.

FIG. 6 is a schematic of using an alternative H shape hollow volume instead of the piston

FIG. 7 is a schematic of using a rolling ring for sealing the water.

FIG. 8 is a schematic of the combination of the aforementioned system in order to have a confident sealing.

FIG. 9 is a schematic of the other design of the total system (named as ditch type system). In this design the power generation system transferred to start of the entrance canal (21) so that the output water flows inside a channel which is in the lower head compared to the river.

FIG. 10 is a schematic of the upper view of the ditch type system.

FIG. 11 represents the application of this system for energy production using sea water.

FIG. 12 is a schematic of head loss in dams.

FIG. 13 is another schematic of head loss in dams.

FIG. 14 is a schematic the head difference between upstream and downstream of the power generating system.

FIG. 15 displays how the piston's weight could be compensated by piston's height.

FIG. 16 displays how the increase of the water head in the pools (2) and (6) is feasible without changing the base of the design.

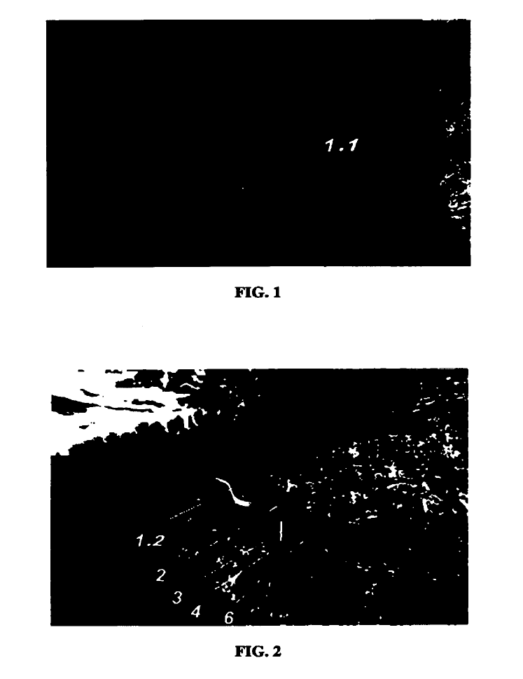

### MECHANICAL DEFINITIONS

Before explaining the work of this project it would be helpful to define some technical terms and mechanical rules that are going to be referred in future arguments. The following list of terms is defined and described in the current section.
Gravity force
Shear stress
Energy head of fluid
Pressure loss
Skin friction drag
Archimedes' law
Buoyancy force

### Gravity Force

Every two objects impose an attraction force on each other. However, the amount of this force is negligible unless one of the objects has a large amount of mass, e.g. the force that earth exerts of objects near its surface, which we now as weight, is nothing more than the gravitational force between earth and its near located bodies.

### Shear Stress

Shear stress is defined as the stress which is applied parallel or tangential to a face of a material, as opposed to a normal stress which is applied perpendicularly. Shear stress imposed on fluids because of the relative motion of an immersed solid body in them, always acts as a retarding force and dissipates energy. The magnitude of the shear stress is mainly commensurate with the relative velocity between fluid and body and fluid material.

### Total Energy of Fluid

Total energy of fluid is the sum of three terms; Potential energy that it has because of its elevation from earth surface, kinetic energy that the fluid acquires as it starts to flow in a direction, and the energy it has because of its pressure. Total energy of fluid will not remain constant as it flows because of the energy dissipated by shear stress between the fluid and it adjacent walls.

### Pressure Drop

As the shear stress affects the total energy of fluid, this energy loss is emerged as decrease is the magnitude of the terms that comprise the total energy of fluid. In flows within channels the velocity of fluid usually remains constant. Thus, in case of a horizontal channel all the energy that dissipates emerges as a drop in the pressure of the flowing fluid.

### Skin Friction Drag

Due to the friction between any moving object and its surrounding air, there exists a resisting force imposed on the object tending to decelerate it. This resisting force is called skin friction drag. Unfortunately, there is no explicit formula in order to calculate the magnitude of this force. From analytical studies it can be just stated that drag force is proportional to the speed of the object or its higher powers. Nonetheless, there are some experimental data and correlations which can be employed to study the dynamics of a moving body in a fluid.

### Archimedes' Law

On any object within a fluid acts a force known as Archimedes' force. This force is originated form the pressure difference among the layers fluid. The amount of this force for a solid body is equal to the weight of an iso-volume body of fluid.

### Buoyancy Force

The net force acted on body submerged in fluid is the summation of weight and Archimedes force. This net force is technically named as the buoyancy force. The buoyancy force may be downward, upward, or zero regarding to a magnitude of r which is a dimensionless parameter defining the ratio of body density to its outer-fluid density. If r>1 then force is downward, r=1 the force is zero, and as when the r is less then unity the force will be upward.

### DETAIL DESCRIPTION OF PREFERRED EMBODIMENTS

The innovation described in this report is a system that extracts mechanical energy of the flowing water in the rivers and other surface water currents. This system can be implemented in almost every location of the river and also for a large range of river sizes. The scheme applied in this system is described as follows.

### List of Parts

1 Open channel
1.1 Proximal end of the open channel
1.2 Distal end of the open channel
7 First check valve
7.1 First check valve in an open position
7.2 First check valve in a closed position
8 Second check valve
8.1 Second check valve in a closed position
8.2 Second check valve in an open position
9 Piston
9.1 Piston in top dead center
9.2 Piston in bottom dead center
30 Height of the Piston (9)

The water is separated from river with the required amount using a secondary outdoor channel (1, proximal end 1.1) near the river (here named as open channel); also the whole amount of river flow could be used if needed.

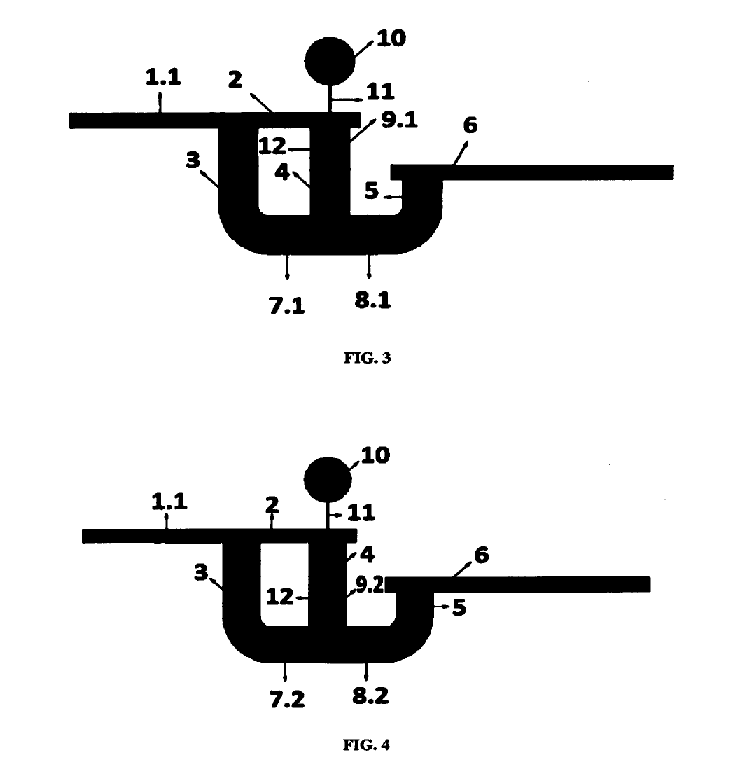

Three interconnected vertical cylindrical canals (3), (4) and (5) are dug in the bed of a riverside. Water enters cylindrical canal (3) and then flows to the other cylindrical canal (4) through a check valve (7, open position 7.1). Water pressure pushes a hollow piston (9) in the second cylindrical canal (4) and generates power as indicated in FIG. 3. In this step a second check valve (8.1) is closed. Then the first valve (7, 7.2) closes when hollow piston (9) riches its top most point (9.1) and the second check valve (8) opens immediately, as the valve (8.2) opens. The pressure of the water inside the second cylindrical canal (4) breaks so that the hollow piston (9) would be able to return to its initial position and the water discharges from an exhaust cylindrical canals (6); see FIG. 4. The hollow piston should have a negligible weight so that it could be constructed from light metals like aluminum of fiber glass and etc.

When hollow piston (9) returns to its initial position (9.2 bottom most point) the propulsion is its own weight; that is not a significant amount, so if the distance between the cylindrical canal (4) and piston (9) didn't seal appropriately the buoyancy force dominates the weight of the hollow piston (9) and resist its downward movement. This problem could be solved first by perfect manufacturing of the piston (9) according to cylinder's (4) diameter. The second proposed mechanism to overcome this problem is using some orifices (14) in the surface of the piston (9) in order to steer the water inside of the piston (9). Making use of this mechanism breaks the connection between the upstream and downstream of the piston (9).

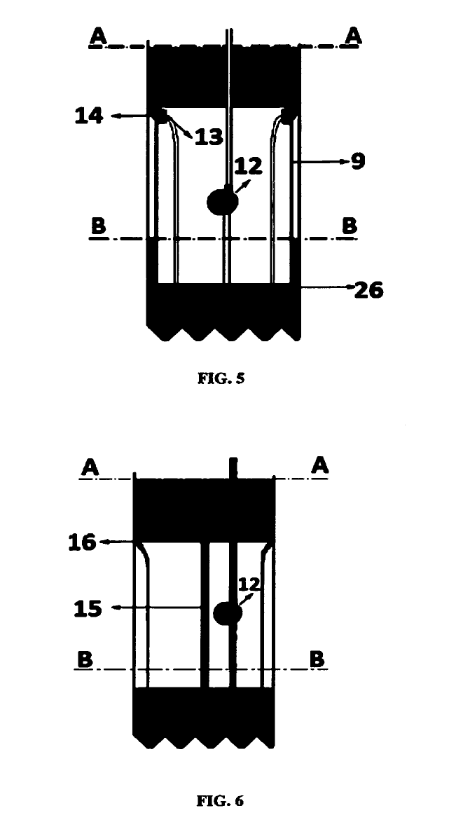

In this system a pump (12) is needed to prevent the accumulation of the water inside of the piston (9); see FIG. 5. A hollow volume (15) as indicated in FIG. 6 could be used as another alternative design to the piston (9). Decreasing the friction between the piston (9) and the wall of the cylindrical canals (4) is one of the great advantages of this mechanism. In this mechanism water leaks through the seam (16) between the volume (15) and the cylindrical canals (4), so the orifices (14) have been eliminated from the previous design.

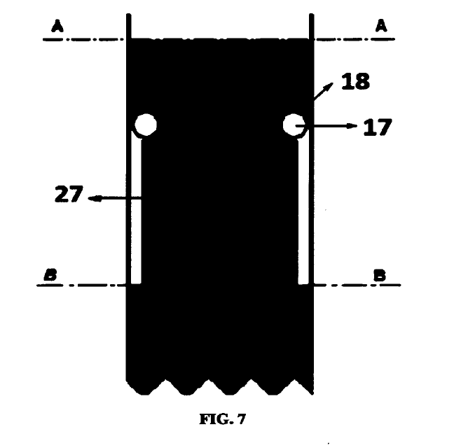

Using roller type (17), (18) sealing is the other procedure which can be used for this work. In this mechanism the light volumetric piston (9) in previous designs might be changed to volume with square cross section (27). Four cylindrical rollers (17) and a rubber diaphragm (18) complete the process of the sealing as shown in FIG. 7. The diaphragm could be constructed from other materials like polymers or even grease.

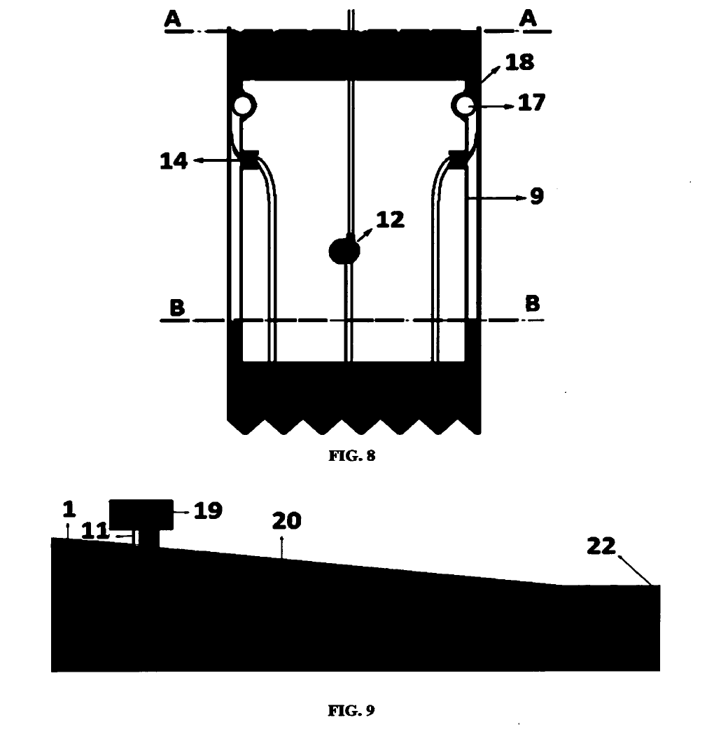

A modulation of the roller type (17), (18) sealing and orifice suction (14) is the other useful replacement for the simple cylinder which is indicated in FIG. 8. This design would ensure the sealing.

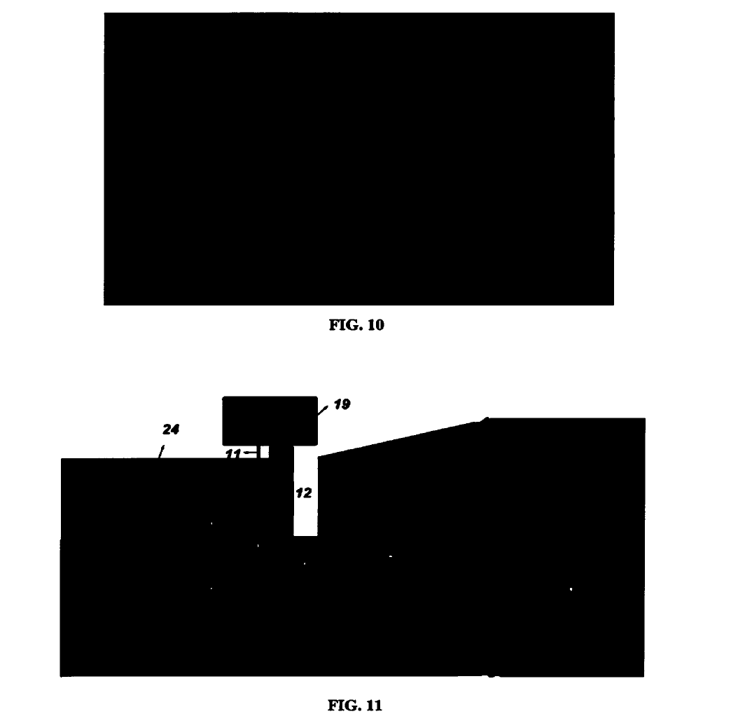

The FIG. 9 displays an analogous design for energy generation which the required cylindrical canals of the system (3), (4), (5) are located at the source of the water extraction open channel (1.1) and the outputted water discharged using a channel (20) which is lower than water level where the original level of the main river (21) is upper than outlet. This channel doesn't need to be an indoor channel so depending on the conditions of the environment it could be a tunnel or an outdoor channel. The upper view of the resent design clarifies how it works (see FIG. 10). In the recent design if the total flow rate of the main river (21) is the target of the power generation system, there is no need to transfer the water to the place near the river and the river bed could be used for manufacturing the system and channels.

This invention helps us to use the seas and oceans (24) which are near the large deserts (25) as the source of water. The system can be implemented near the sea (24) and the outlet water can be discharged in to the underground aquifers or to the sandy grounds. See FIG. 11. Application of this invention prepares great advantages to the countries that have not rivers with high flow rates.

### Pros and Cons

Due to the increasing demand for energy and shortage of fossil fuel resources, there has been a concern for energy resources in the past decades. One of the energy resources is the flow of water in river and other natural water currents. The system proposed in this work has eliminated the problems with hydrodynamic power plants; such as, environmental issues, ecosystems degradation, and the heavy costs of constructing and maintaining these enterprises.

The aforementioned system makes us of very simple establishments which will not release any pollution into the surrounding ecosystem. The overall cost of equipment is much less than expensive turbines. At the same time, the maintenance cost is reduced up to 95%. This system requires very limited space and can be used in almost all conditions. Dams with the huge structures have been omitted in our design trying to minimize environment destruction. No water storage utilized in this method and the fluid currency remains steady during the process of energy generation. The invention could be manipulated for the rivers with the fewer slopes where construction of a dam is not possible. According to the simulations done for this mechanism using computational fluid dynamics (CFD) methods, the efficiency of this mechanism is more than water turbines and also the whole amount of fluid energy from the source till the ocean could be obtained using this mechanism. The needing time for construction and launching of the system is much less compared to the dams. All these points combined, this system will be a very good response to the increasing energy demand.

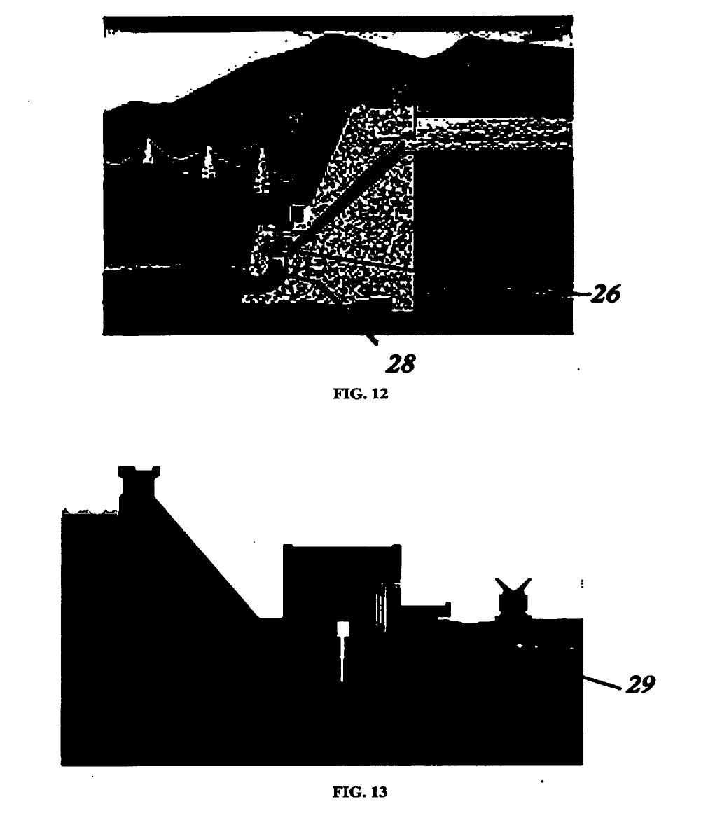

The great advantage of the recent innovation comparing with the other hydropower generation systems is the utilizing of the entire head of the water. In other word there are only frictional head losses in this system but in the other similar systems there is at least another head loss due to the head of the power generator itself. In turbines, for example the height of the turbine's blade (26) and other possible facilities (28) consumes some efficient head of the river (27), See FIG. 12.

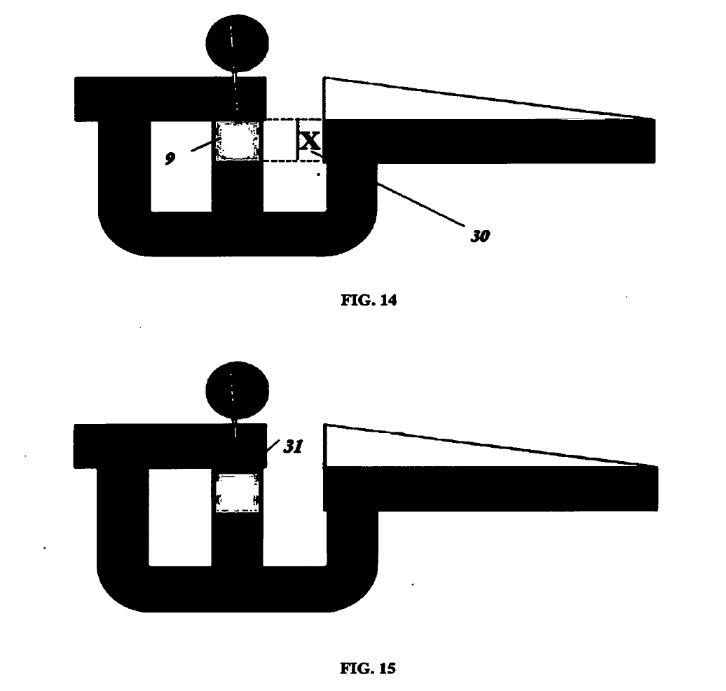

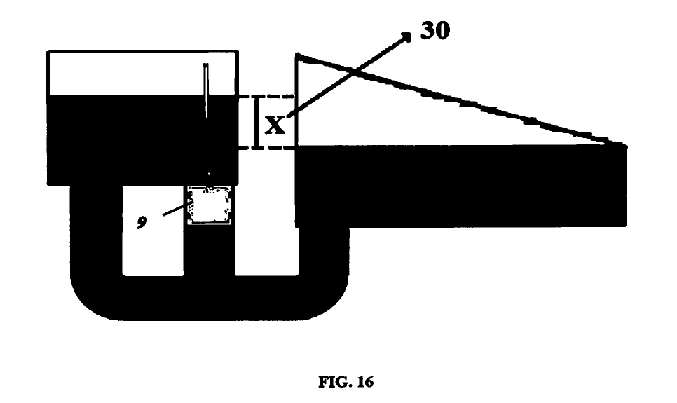

When the turbines is setting up in the depth of the dam as displayed in FIG. 13 the downstream head of the water (29) exerts an opposing force to the turbine blades and causes the decrease in the generated power. However in the recent innovation the difference between the upstream and downstream head of the system (30) is exactly as the same as piston's (9) height so no consumption of energy occurs by the height of the system (See FIG. 14). If the weight of the piston (9) be significant, the height of the piston (9) could be increase to the extent that the buoyancy force compensates the weight of the piston. The increased height (31) has been shown in FIG. 15. In other words the total head of water could be used in this innovation and only frictional head losses occur in the cycle.

It might be thought that the system is slow when the piston is coming backward because of its low water head in the pools (2) and (6). But this could be solved by increasing the water height inside the pools (2) and (6) without any changing in the basis of the mechanism and also this improvement prevent the creation of the turbulence effects in the exhaust of the pools. This improvement causes the system works in a more stable state.

1. A mechanical power generating system using buoyance energy comprises: A housing, comprising three vertical pipes and a hollow moving object; wherein said hollow moving object moves in a vertical position and upwards due to water pressure under said hollow piston and downward position due to its weight; creating a reciprocating machine; three interconnected vertical cylindrical canals (first, second and third cylinders) are dug in a bed of a waterside; water from said riverside enters said first cylinder and then flows in to said second cylinder through first check valve in its open position, while a second check valve is in its closed position; said water pushes said hollow moving object that is located inside said second cylinder upwards generating power; when said hollow moving object reaches a maximum height said second check valve opens immediately and therefore allows water inside said second valve to reduce and therefore said hollow moving object returns downwards to its initial position; said water discharges from an exhaust cylindrical canal different from said first, second and third canals.

2. The system of claim 1, wherein said first, second and third cylinders are located between an open channel of said waterside and wherein said water exits through an exit channel has a lower water level in comparison to said open channel, therefore said exit channel is located in a deeper/lower height in comparison to said open channel allowing an outpour of said water after it has been used in utilization of electrical energy and back to nature.

3. The system of claim 2, wherein said flow rate of a river/ocean or sea is utilized for power generation and said system is installed near said waterside and no additional means is necessary for transportation of water to an off shore facility.

4. The system of claim 3, wherein said hollow moving object is a light weight and voluminous piston.

5. The system of claim 4, wherein said piston comprises multiple orifices at its proximal end in order to remove any water from an inside of said piston; and wherein said system further comprises a pump located inside said piston, pumping out excess water inside said piston and therefore preventing accumulation of water inside said piston.

6. The system of claim 3, wherein said hollow moving object comprises an “I” shaped configuration and further comprises at least two seams where said water leaks trough said seams located between said moving object and a wall of said second cylinder, decreasing friction between said wall of said second cylinder and said moving object; and said hollow moving object comprises a pump located alongside a vertical wall of said “I” shaped configuration, pumping out excess water accumulated between said wall of said second cylinder and said hollow moving object.

7. The system of claim 3, wherein said hollow moving object comprises a rectangular or squared configuration and further comprises four roller type sealing means and a diaphragm; sealing an edge of said hollow moving object in order to reduce a chance of water leakage between a wall of said second cylinder and a wall of said hollow moving object.

8. The system of claim 7, wherein said diaphragm is a rubber diaphragm, however other materials such as polymers or even grease can be used.
